(19) United States
(12) Patent Application Publication
(10) Pub. No.: US 2006/0072388 A1
(43) Pub. Date: Apr. 6, 2006

(54) Pivoting optical device

(75) Inventor: Gerard Eduard Rosmalen, Mierlo (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONIC N.V.

(21) Appl. No.: 10/535,461

(22) PCT Filed: Oct. 29, 2003
(86) PCT No.: PCT/IB03/04916

§ 371 Date: May 17, 2005

(30) Foreign Application Priority Data
Nov. 22, 2002 (EP) 02079948.2

(51) Int. Cl. G11B 7/00

(52) U.S. Cl. 369/44.19; 369/44.11; 369/44.14; 369/44.17

(57) ABSTRACT

Pivoting optical device comprising a first part (15) and a second part (17) with optical means which is pivotally movable relative to the first part about a first pivot axis (19), said optical means defining an optical laser beam path (21) in the general longitudinal direction of the second part, and further comprising bearing means (23) comprising the first pivot axis and a point laser source (25) fixedly connected to the first part for providing a laser beam in the general direction of said second part. According to the invention, the laser source is located in said optical laser beam path in the general longitudinal direction of the second part, and the bearing means present an open center region (29) so that a laser beam is allowed to pass from the laser source to the second pivotally movable part.

The invention relates to a pivoting optical device of the type defined in the preamble of claim 1.

Pivoting optical devices of this kind may be used, for example, to scan a surface of a substrate with an optical probe in a direction generally parallel to the substrate surface and in a direction perpendicular to the substrate surface. Optical devices of the kind referred to above are also used, for example, in optical disc apparatus to read and possibly record information from/into an optical disc, but could also be used with barcode readers, measuring equipment, etc.

Japanese document JP-2001 357 547 A discloses a pivoting optical device of the kind referred to above for scanning optical discs. The device comprises a swing arm which is pivotally movable about a swing axis near one of its ends, an optical focusing unit being provided at the opposite free end. The optical focusing unit comprises optical lens means which are axially movable relative to the swing arm structure so as to provide a focusing function. Optical elements are located in the swing arm, providing an optical path from a semiconductor laser diode to the optical focusing unit and back to an optical sensing device.

According to the cited JP document, the laser diode may be provided in the swing arm itself near the swing axis. As an alternative, it may be provided in a separate stationary structure apart from the swing arm itself. The preamble of claim 1 therein refers to the latter kind of solution. In the cited Japanese document, said separate structure is located over the pivoting end of the swing arm, and the laser diode is positioned such that the laser beam emitted from the laser diode is directed along the swing axis, a reflecting optical deflection element being provided in the swing arm to deflect the laser beam in the direction of the optical focusing unit at the free end of the swing arm.

Providing the diode laser in the swing arm itself presents the obvious disadvantages of an increased swing arm mass, not only of the diode laser proper but also of its mount and the unavoidable connecting leads. A major problem is also the heat generated by the laser diode. In some cases, such as in swing arm devices for optical disc drives, providing sufficient cooling of the pivotable moving second part may be impossible, which will ultimately lead to the destruction of the laser diode. Even if sufficient cooling is provided, the resulting thermal load has a negative impact on the geometrical stability of the swing arm structure as a whole and the relative positions of the optical elements present in the swing arm.

Providing the diode laser as a separate stationary unit in accordance with the cited Japanese document increases the overall axial dimensions of the optical swing arm arrangement. The optical deflection element which is needed still adds to the mass of the swing arm. The means for moving the optical focusing elements of the optical focusing unit also increase the movable mass of the swing arm.

The problems of the prior art indicated above interfere with the ever ongoing trend towards miniaturization which can be observed in the industry and more particularly in the areas of information technology and communication technology.

It is therefore an object of the invention to provide a novel and useful optical device of the kind described in the introduction which is highly suitable for miniaturization and needs fewer optical elements by combining the features defined in claim 1. In this way the overall axial dimensions of the optical unit are reduced. The optical deflection element discussed above is not needed.

The invention may be advantageously used in a pivotal optical device according to claim 2. This embodiment is characteristic of the versatility of the invention, which may be used in optical devices of a more complicated nature exhibiting combined pivotal movements.

A preferred embodiment of the invention is defined in claim 3. Bearing means of the gimbal type are highly suitable for the optical device of the invention. The intermediate part may provide an open central part of dimensions which may be conveniently matched to the dimensions of the laser diode and its mount, without impacting on the dimensions of the second pivotally movable part of the pivoting optical device.

An embodiment of the invention is preferred in accordance with claim 4. Many semiconductor lasers, if not most, exhibit a far field of generally oblong shape, due to the physical nature of the semiconductor element emitting the laser beam. As an example, reference is made to a specification sheet regarding the NDHV310AA high-power violet laser diode available from Nichia Europe B.V., a company with offices in Amsterdam, The Netherlands, exhibiting a dimensional ratio between the minor axis and the major axis of approximately 1:3. Many pivoting optical devices which pivot in two mutually perpendicular directions do so with a larger amplitude in one direction and with a smaller amplitude in the other direction. The generally oblong nature of the far field pattern of the semiconductor diode laser, in many cases regarded as an unfortunate characteristic, may be completely compatible with the operation of the optical device according to the invention owing to a judicious orientation of the far field pattern relative to the first and second pivoting axes of the device.

A further embodiment of the invention is defined in claim 5, where the collimating lens, used to collimate the laser beam and often present in optical devices of the kind wherein the invention may be used, is strategically placed relative to the laser source so that no room is wasted. If the laser source exhibits a generally oblong far field pattern, an embodiment may be used in accordance with claim 6 so as to ensure that the collimator lens is always within the far field pattern of the laser beam.

A highly practical embodiment of the invention is defined in claim 7. A swing arm device having a rigid swing arm structure which may pivot in two mutually orthogonal directions is described in Applicant's copending patent application filing nr. 0278881.6, filed on 19 Sep. 2002 but not published prior to the priority date of the present application, the contents of which are incorporated herein by reference.

The objects and features of the invention will become more apparent from the following non-limiting description of a preferred embodiment given with reference to the accompanying drawings, in which:

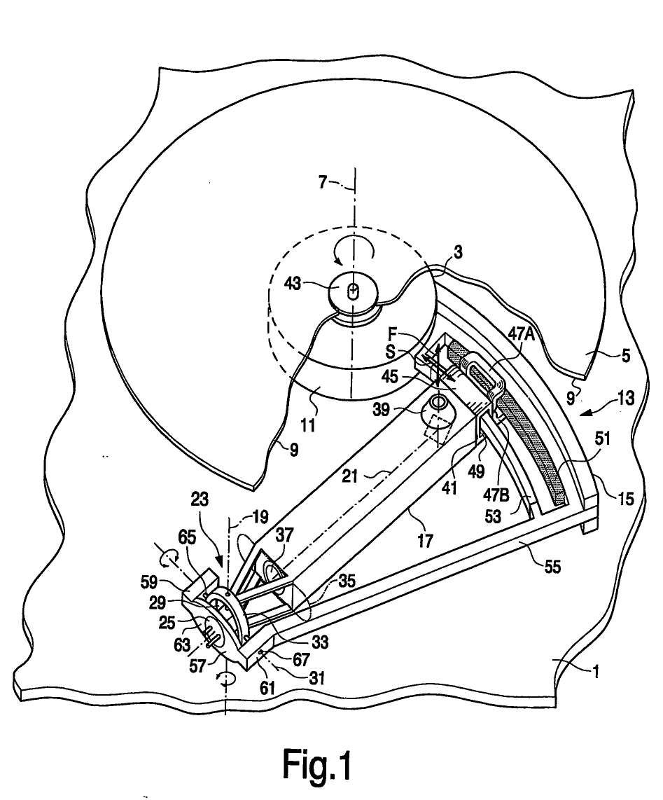

FIG. 1 is a schematic perspective fragmentary view of a pivotal optical device in the form of a swing arm device for use in an optical disc drive according to the invention,

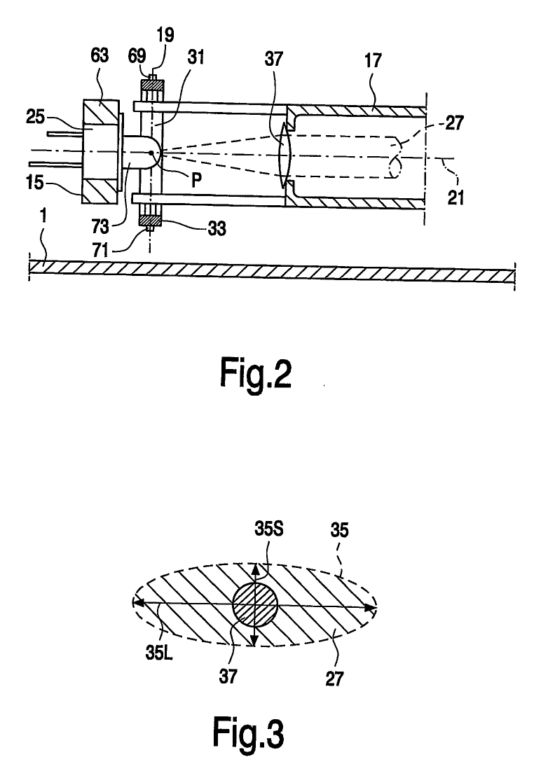

FIG. 2 is a fragmentary side elevation view in cross-section, illustrating a detail of FIG. 1 on an enlarged scale,

FIG. 3 is a diagram showing in plan view the relation of the dimensions of a collimator lens of the optical disc drive of FIG. 1 to a laser diode far field pattern in which the collimator lens moves,

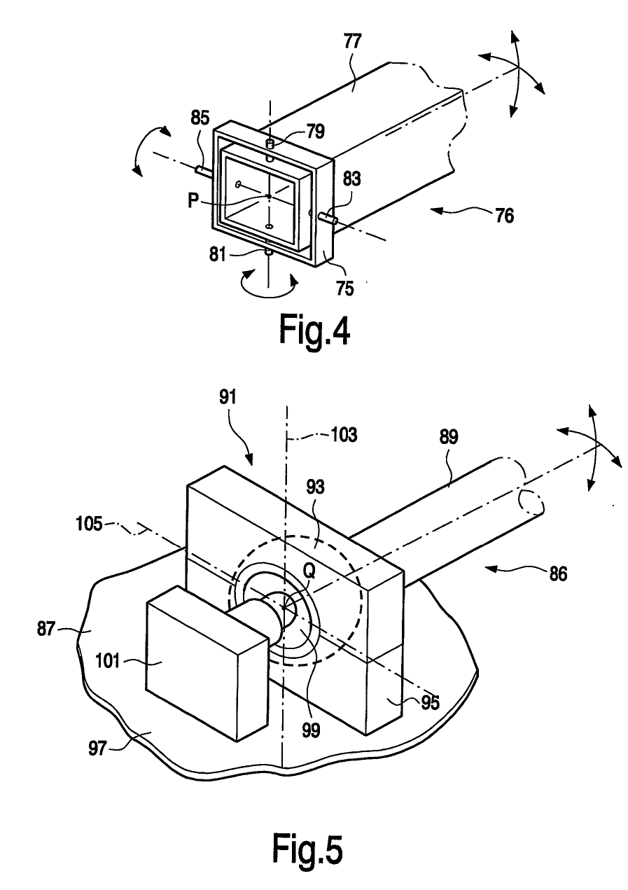

FIG. 4 is a fragmentary perspective detailed view of parts of an alternative embodiment of the device of FIG. 1, and

FIG. 5 is a view similar to FIG. 3 of an alternative embodiment of the invention.

The drawings are of a schematic nature and intended for illustration purposes only. The details in the Figures are drawn to an arbitrary scale which may be different from the overall scale. The same components are indicated by the same reference number throughout the Figures. Components and assemblies which may be configured according to principles which are basically known from the prior art will not be discussed in detail.

Referring to FIG. 1, a pivoting optical device is shown in the form of an optical disc drive of a general design disclosed in Applicant's copending patent application, filing nr. 02078880.8 filed on 19 Sep. 2002 but not published prior to the priority date of the present application and incorporated herein by reference. The optical disc drive of FIG. 1 comprises a base plate 1 supporting a spindle motor 3 for rotating an optical disc 5 about a spindle axis 7, the optical disc 5 comprising an information surface 9 at its lower side. A peripheral outer surface 11 of the spindle motor 3 has a pivoting optical device 13 attached to it, spaced from the base plate 1. It comprises a first part generally denoted by the reference number 15 and a second part generally denoted by the reference number 17 with optical means and pivotally movable relative to the first part 15 about a first pivot axis 19, said optical means defining an optical laser beam path 21, the general direction of which is symbolically indicated by a dash-dot line and extends in the general longitudinal direction of the second element 17. Bearing means, generally denoted by the reference number 23, are provided comprising the first pivot axis 19 as well as a point laser source 25 fixedly connected to the first part 15 for providing a laser beam 27 (see FIG. 2) in the general direction of said second part 17.

The laser source 25 is located on said optical laser beam path 21 in the general longitudinal direction of the second part 17, and the bearing means 23 presents an open center region 29 so as to allow the laser beam 27 to pass from the laser source 25 to the second pivotally movable part 17.

The second part 17 is also pivotally movable relative to the first part 15 about a second pivot axis 31 substantially orthogonally intersecting the first pivot axis 19 at a point of intersection P, the laser source 25 being located at the point of intersection P of said intersecting first and second pivoting axes 19, 31.

The bearing means 23 is of the gimbal type, comprising an intermediate bearing element 33 which is pivotally supported by the first part 15 and which in its turn pivotally supports the second part 17, said point of intersection P being located at the center point of the intermediate bearing element 33.

The laser source 25 is a semiconductor diode laser unit of a type known per se that exhibits a far field radiation pattern 35 (see FIG. 3) in a generally transverse cross-section of the radiation beam 27 of generally oblong shape, with a major pattern axis 35L and an orthogonal minor pattern axis 35S. The semiconductor laser diode 25 is arranged such that the major pattern axis 35L is generally parallel to the second pivotal axis 31 and the minor pattern axis 35S is generally parallel to the first pivotal axis 19.

The optical means of the second part 17 comprises an optical collimating means in the form of a collimating lens 37 at the point of entry of the laser beam 27 emitted by the diode laser 25 into the second part 17. The collimating lens 37 is wholly positioned within the generally oblong far field pattern 35 of the semiconductor diode laser 25 in all operational pivotal positions of the second part 17.

The pivoting optical device described so far is a swing arm device for supporting an optical focusing unit 39 near its free end 41 for reading/recording information from/into the information surface 9 of the optical disc 5 disposed on a rotating spindle 43 of the spindle motor 11. The second part 17 is a rigid swing arm for pivotal scanning movements about a swing axis which is the pivot axis 19, and for pivotal focusing movements about a focusing axis, which is the second pivot axis 31 that substantially orthogonally intersects the swing axis at P for moving the optical pickup unit 39 in substantially orthogonal scanning and focusing directions F and S, respectively, relative to the information surface 9 of the optical information disc 5. The major pattern axis 35L (FIG. 3) of the far field pattern 35 is generally parallel to the focusing axis 31 and the minor pattern axis 35 S of the far field pattern is generally parallel to the swing axis 19.

The embodiment of the swing arm device shown in FIG. 1 is of a type in which the second part is a rigid swing arm structure which pivotally moves as a whole about the swing axis 19 and the focusing axis 31. Too enable these pivotal movements, magnetic scanning and focusing means are provided, comprising the first part 15 which is of magnetically permeable material and acts as a stator structure and a number of movable magnetic coils 45;47A,B which are provided at the free end 41 of the swing arm structure for scanning and focusing, respectively. The movable magnetic scanning coil comprises a cylindrical scanning coil 45 having a generally rectangular shape in cross-section and having a central opening 49. The movable focusing coils are two substantially identical cylindrical focusing coils 47A,B, respectively, having a generally rectangular shape in cross-section. The scanning coil 45 has been bonded with an outer side surface against the free end 41 of the swing arm structure 17 in a position in which its central axis is generally parallel to the scanning movements S of the swing arm structure, using suitable means such as adhesive means. Each focusing coil 47A,B has been bonded at a portion of its outwardly facing axial end surface against an outer side surface of the scanning coil 45 which is remote from the swing arm structure 17 by suitable bonding means such as adhesive means, the two focusing coils 47A,B being disposed in the manner generally shown in FIG. 1. The first part 15 supports stationary magnetic means comprising an elongate permanent magnet means 51 facing the focusing coils 47A,B and spaced therefrom by an air gap. The magnetically permeable stator or first part 15 has a stator part 53 passing through the central opening 49 of the scanning coil 45 with clearance, the permanent magnet means 53 being magnetically polarized in a radial direction relative to the swing axis 19 of the swing arm structure or second part 17, the arrangement being such that a substantially radially directed permanent magnetic field is established across the air gaps which are present between the scanning coil 49 and the stator part 53 and between the focusing coils 47A,B and the stator 15, respectively. The stator 15 is rigidly associated with the spindle motor 3.

The stator core 15 and supporting portions of the gimbal-type bearing means 23 are integrated into a combined unit. This combined unit is made from a suitable magnetically permeable material such as soft iron and comprises a temporarily removable part, the part 53, to enable insertion of the scanning coil 45 into the central opening 49. The combined unit is provided with an interconnecting supporting beam part 55 carrying the bearing means 23 near its free end and may be comprised of a stack of stator laminations which may be integrated with the motor stator of the spindle motor 3.

More detailed descriptions of swing arm devices of the general kind shown in FIG. 1 may be found in the previously mentioned patent application, filing nr. 02078880.8.

FIG. 1 illustrates that the second part 15 is generally U-shaped in plan view at its free end 57, comprising two legs 59,61 and a connecting part 63. Pivoting pins 65,67 pivotally support the intermediate part 33 in the legs 59,61, respectively. In turn, the second part 15 is pivotally carried by the intermediate bearing part 31 by two pivoting pins 69,71, respectively (FIG. 2). The diode laser is inserted in a matching opening in the connecting part 63 of the U-shaped end part of the second part 15 in such a way that the active diode surface (not shown), which is housed inside a laser beam transparent protection cap 73 and emits the laser beam 27, is situated at the point of intersection P of the swing axis 19 and the focusing axis 31 of the second part 17.

FIG. 3 shows a projection of the collimating lens 37 as a circular shaded area, projected onto the local far field pattern shown as a differently shaded area in a projection plane orthogonally passing through the plane of the collimating lens 37. The collimating lens 37 remains within the boundaries of the far field pattern 35 in all operational positions of the swing arm device 13 of FIG. 1 swinging about the swing axis 19 and the focusing axis 31. The focusing amplitudes of swing arm devices for optical disc drives being much smaller than the swing amplitudes, a far field pattern of oblong shape or generally unidirectionally extended shape appears to be highly suitable in a pivoting optical device for optical disc drives.

FIG. 4 demonstrates that with bearings of the gimbal type suitable for the invention the intermediate part need not be circular as in FIG. 1. A pivoting optical device 76, only part of which is schematically shown, comprises an intermediate part 75 of generally square shape, pivotally supports a second part 77 by means of two pivot pins 79,81, and is provided with two further pivot pins 83,85 for cooperation with a first part (not shown). It will be appreciated that intermediate parts of any suitable shape may be used for the purposes of the invention.

To illustrate that other suitable bearing means may alternatively be used, depending on the nature of the application and the structure of the pivoting optical device, FIG. 5 schematically shows a detail of an optical device 86 of a different kind, comprising a first part 87 and a hollow tubular second part 89. The bearing means is a spherical bearing arrangement 91 of swivel joint type comprising a partly spherical movable bearing part 93, omnidirectionally rotatably restrained in a matching outer stationary part 95 connected to a base plate 97. The hollow tubular first part 89 penetrates the spherical part 93 so that an opening 99 in the first part is exposed on a side of the spherical part opposite to the side facing the major portion of the first part. A point radiation source is supported on a stationary mount 101 facing the opening 99 and penetrating it such that the active part of the point radiation source is located in the point of intersection Q of two orthogonal pivot axes 103 and 105 of the bearing means 91.

While several embodiments of an optical disc device according to the invention have been described, it will be appreciated by persons skilled in the art that the invention is not limited by what has been particularly described and shown above. Many modifications are possible without departing from the inventive concepts herein, all comprising the main feature of the invention, which is that in a pivoting optical device a laser source is located in an optical laser beam path in the general longitudinal direction of a second part, and bearing means present an open center region so as to allow a laser beam to pass from a laser source to the second pivotally movable part. Different designs of bearing means may be used or conceived, for example comprising flexible pivot elements instead of or in addition to mutually movable pivot elements.

1. A pivoting optical device, comprising:
a first part,
a second part provided with optical means and pivotally movable relative to the first part about a first pivot axis, said optical means defining an optical laser beam path in the general longitudinal direction of the second part,
bearing means comprising the first pivot axis,
a point laser source fixedly connected to the first part for providing a laser beam in the general direction of said second part, wherein:
the laser source is located in said optical laser beam path in the general longitudinal direction of the second part, and
the bearing means presents an open center region so as to allow a laser beam to pass from the laser source to the second pivotally movable part.

2. A pivoting optical device according to claim 1, wherein the second part is also pivotally movable relative to the first part about a second pivot axis substantially orthogonally intersecting the first pivot axis at a point of intersection, the laser source being located at the point of intersection of said intersecting first and second pivoting axes

3. A pivoting optical device according to claim 2, wherein the bearing means is of the gimbal type, comprising an intermediate bearing element which is pivotally supported by the first part and which in its turn pivotally supports the second part, said point of intersection being located at the center of the intermediate bearing element.

4. A pivoting optical device according to claim 2, wherein:
the laser source is a semiconductor diode laser unit of a type known per se exhibiting a far field radiation pattern in a generally transverse cross-section of the radiation beam of generally oblong shape, with a major pattern axis and an orthogonal minor pattern axis, and
wherein the semiconductor laser diode is arranged such that the major pattern axis is generally parallel to one of the first and second axes, and the minor pattern axis is generally parallel to the other one of the first and second axes.

5. A pivoting optical device according to claim 2, wherein said optical means of the second part comprises optical collimating means at the point of entry of a radiation beam emitted by the laser source into the second part.

6. A pivoting optical device according to claim 4, wherein the collimating means is wholly positioned within the generally oblong far field pattern of the semiconductor diode laser in all operational pivotal positions of the second part.

7. A pivoting optical device according to claim 4, wherein the pivoting optical device is a swing arm device for supporting an optical focusing unit near its free end for reading/recording information from/into an information surface of an optical disc disposed in an optical disc apparatus, the second part being a rigid swing arm for performing pivotal scanning movements about a swing axis and for performing pivotal focusing movements about a focusing axis that substantially orthogonally intersects the swing axis so as to move an optical pickup unit in mutually substantially orthogonal scanning and focusing directions, respectively, relative to the information surface of the optical information disc, and wherein:
the major pattern axis of the far field pattern is generally parallel to the focusing axis, and
the minor pattern axis of the far field pattern is generally parallel to the swing axis.
